(19) United States
(12) Patent Application Publication
(10) Pub. No.: US 2007/0180975 A1
(43) Pub. Date: Aug. 9, 2007

(54) GUITAR WITH ACOUSTICAL MIXING CHAMBER

(76) Inventors: Rainer K. Paris, Brookfield, WI (US); Louise M. Paris, Brookfield, WI (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/671,106

(22) Filed: Feb. 5, 2007

Related U.S. Application Data
(60) Provisional application No. 60/765,409, filed on Feb. 6, 2006.

(51) Int. Cl. G10D 3/00

(52) U.S. Cl. 84/291

(57) ABSTRACT

A musical instrument having a body defining a substantially hollow volume, a neck coupled to the body, at least one string tensioned between the body and the neck, and a sound module positioned in the body and including a speaker having a front surface communicating directly with the hollow volume. In one embodiment, the speaker is part of a sound module that is positioned within the body of the guitar. Preferably, the sound module further includes an amplifier, a power switch, a volume control, an audio input (e.g., a wireless audio input or an audio input jack), and a battery compartment. A second aspect of the present invention is that the speakers do not face in a direction that is perpendicular to the plane defined by the soundboard. Rather, they face in a direction that is at some other angle, such as angled at least about thirty degrees from being perpendicular to the plane. Preferably, the speakers are angled at least about sixty degrees and, most preferably, ninety degrees from being perpendicular to the soundboard plane. A third aspect of the present invention is that the sound module is positioned in the lower bout of the guitar body and is not directly supported by the soundboard. In one embodiment, the sound module is supported by the back wall and does not touch the soundboard.

### BACKGROUND

The present invention relates to guitars, and particularly to guitars having built-in speakers.

It is known to provide acoustic guitars with electronic pick-ups so that the sound of the guitar strings can be amplified. These pick-ups are commonly mounted to the guitar so that the vibration of the guitar strings can be transferred to an amplifier and subsequently to a speaker for transmission of the sound to the audience.

In some recent designs, the amplifier and speaker are mounted to the guitar body so that a separate amplifier and speaker are not required. In these designs, the speaker is typically mounted to the soundboard of the guitar and facing outward toward the audience so that the sound of the speaker is transmitted directly to the audience. The speaker can be mounted in the normal sound hole of the guitar, or in a separate sound hole formed in the soundboard. Alternatively, the speaker can be mounted up against the back of the soundboard without a dedicated sound hole. In any of these designs, the guitar body is being used as a speaker box to support the speaker in an orientation that directs the sound away from the guitar body. As a result of these designs, the sound emanating from the speakers is transmitted directly to the audience either through the dedicated sound hole or, when no dedicated sound hole is used, through the soundboard.

### SUMMARY

The present invention was developed as a result of the recognition that the sound emanating directly from a speaker does not have the same sound quality as the original acoustical sound being created by the guitar. This results from the fact that the speakers in the above-described systems face outward toward the audience, and thus results in sound that emanates directly from the speaker. In addition, by mounting the speaker to the soundboard, the above-described guitars disturb the natural frequency of the soundboard, resulting in an unnatural sound.

The present invention achieves a different sound quality by positioning the speaker such that the front surface of the speaker is in direct communication with the hollow volume of the guitar body. In this manner, the sound from the speakers is mixed with the natural sound of the guitar, and thus the guitar body is used as an audio mixing chamber. In one embodiment, the speaker is part of a sound module that is positioned within the body of the guitar. Preferably, the sound module further includes an amplifier, a power switch, a volume control, an audio input (e.g., a wireless audio input or an audio input jack), and a battery compartment.

A second aspect of the present invention is that the speakers do not face in a direction that is perpendicular to the plane defined by the soundboard. Rather, they face in a direction that is at some other angle, such as angled at least about thirty degrees from being perpendicular to the plane. Preferably, the speakers are angled at least about sixty degrees and, most preferably, ninety degrees from being perpendicular to the soundboard plane. By virtue of this arrangement, it is believed that the sound from the speakers has a better opportunity to mix with the natural sound of the guitar before emanating from the guitar body.

A third aspect of the present invention is that the sound module is positioned in the lower bout of the guitar body and is not directly supported by the soundboard. In one embodiment, the sound module is supported by the back wall and does not touch the soundboard. By virtue of this feature, the sound module does not substantially interfere with the vibration and sound quality of the soundboard, thus facilitating a more natural acoustic sound from the guitar.

Other aspects of the invention will become apparent by consideration of the detailed description and accompanying drawings. Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### BRIEF DESCRIPTION OF THE DRAWINGS

FIG. 1 is a front view of a guitar embodying the present invention;

FIG. 2 is a back view of a guitar of FIG. 1;

FIG. 3 is a side view of the guitar of FIG. 1;

FIG. 4 is an enlarged perspective view of a sound module that is part of the guitar of FIG. 1.

FIG. 5 is a back view of a different guitar that is a second embodiment of the present invention.

FIG. 6 is a schematic diagram of the electronics of the sound module.

### DETAILED DESCRIPTION

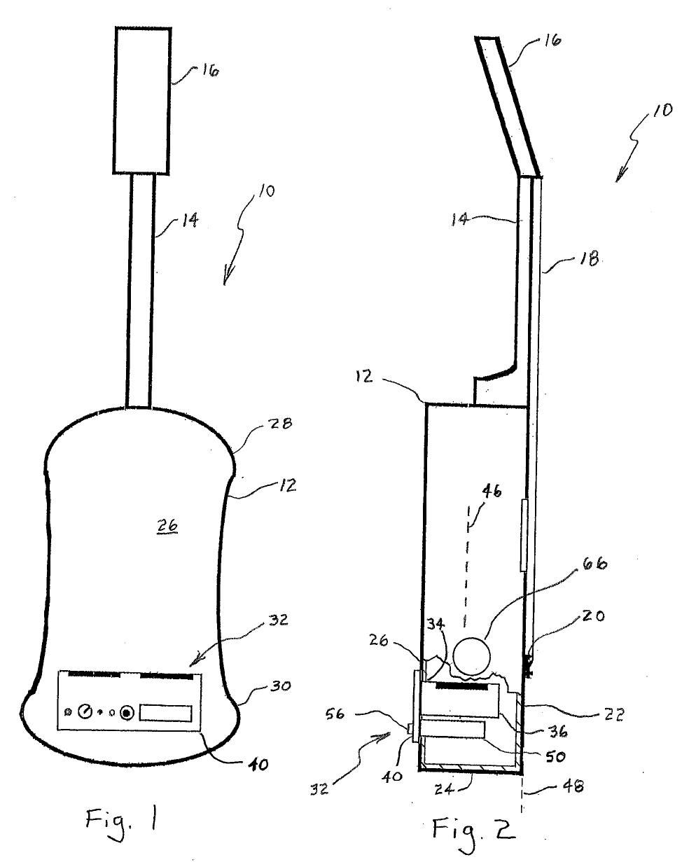

The guitar 10 illustrated in FIGS. 1-3 is similar to a common acoustic guitar having a substantially hollow body 12, a primary sound hole 13, a neck 14 connected to the body 12, a head 16 connected to the neck 14, and strings 18 connected between the head 16 and the body 12. A bridge 20 is connected to the body 12 to support the strings 18.

As is typical with acoustic guitars, the illustrated guitar 10 includes a soundboard 22, a side wall 24 connected to the soundboard 22, and a back wall 26 connected to the side wall 24. The illustrated guitar 10 includes a narrow waist that divides the body 12 into an upper bout 28 and a lower bout 30.

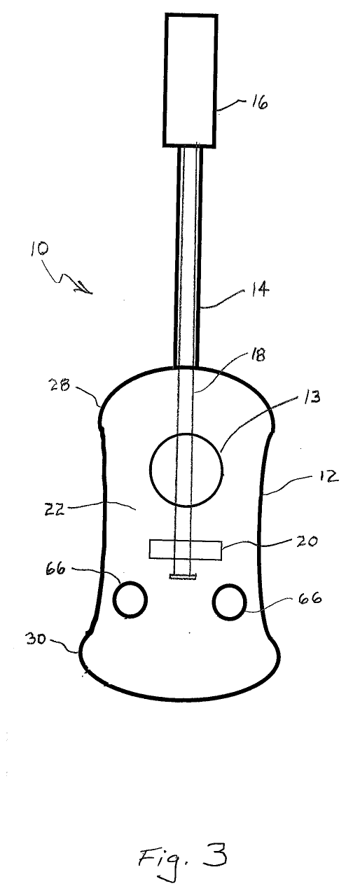

In accordance with the present invention, the illustrated guitar 10 further includes a sound module 32 mounted in the body 12. The sound module 32 is positioned within a hole 34 in the back wall 26, and is supported by the back wall 26. The sound module 32 is spaced from and is not directly supported by the soundboard 22. As best shown in FIG. 2, the sound module 32 is cantilevered from the back wall 26, and does not directly contact the side wall 24 and the soundboard 22.

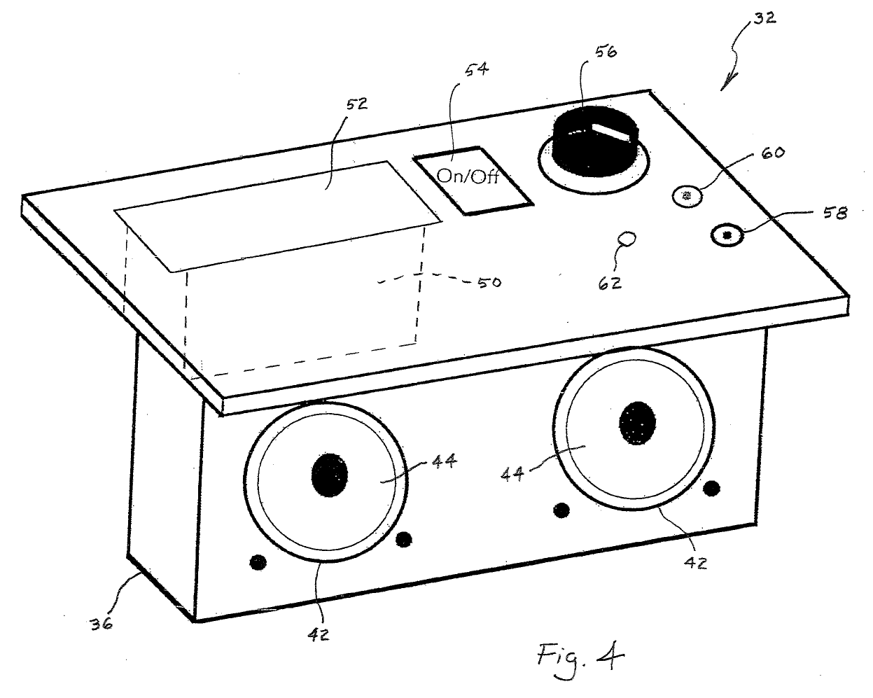

Referring to FIG. 4, the sound module 32 includes a sound box 36, and a cover plate 40 connected to the sound box 36. The illustrated sound box 36 is a substantially hollow, rectangular box that supports two stereo speakers 42. The speakers 42 each include a front surface 44 that faces outwardly into the hollow volume of the body 12. More specifically, the speakers 42 face in a direction 46 that is substantially parallel to a plane 48 defined by the soundboard 22. As used herein, a “speaker” is any sound-producing device.

The cover plate 40 provides a location for mounting various electronic components of the sound module 32 and provides an aesthetically-pleasing outer surface for the sound module 32. The cover plate 40 supports a battery compartment 50 that receives four AA batteries (not shown) for powering the sound module 32.

The cover plate also supports a battery door 52 that facilitates access to the battery compartment 50. The cover plate 40 further supports a power switch 54 for turning the sound module 32 on and off, a volume control 56 for adjusting the volume emanating from the speakers 42, an AC/DC input 58 for providing external power to the sound module 32, and a stereo input 60 for allowing an external audio signal to be provided to the sound module 32. The illustrated stereo input 60 facilitates connection to the headphone jack of an audio device, such as a CD player, a cassette player, an MP3 player, or a computer. The cover plate 40 further includes a power indicator light 62 that is illuminated when the power switch 54 is on. In the illustrated embodiment, the sound module 32 further includes a wireless receiver 64 (FIG. 6), in the form of an FM receiver, that facilitates FM audio input to the sound module 32. The illustrated embodiment also includes a wireless transmitter 65 for transmitting a sound signal from the guitar to a remote location, such as a wireless amp and speaker.

Referring to FIGS. 2 and 3, the illustrated guitar 10 also includes auxiliary sound holes 66 positioned in the soundboard 22 and in the side wall 24 in the lower bout. The auxiliary sound holes 66 are positioned in front of the speakers 42 so that sound generated by the speakers 42 can more easily exit the body 12 of the guitar 10.

In operation, the illustrated guitar 10 can be used and played as a standard acoustic guitar. Due to the placement of the sound module 32 in the lower bout 30 and spaced from the soundboard 22, the guitar 10 is capable of producing a pleasant acoustic sound even with the sound module 32 positioned in the body 12.

In the event that it is desired to have musical accompaniment for the guitar 10, audio signals can be input to the sound module 32 either wirelessly or through the stereo input 60. With the sound module 32 turned on and the volume adjusted to an appropriate level, the audio will be played through the speakers 42 and into the hollow volume of the body 12. By directing the speaker sound into the hollow volume, the audio will mix with the sound from the guitar 10 to create a unique acoustical sound emanating from the guitar 10. In other words, the hollow volume of the guitar body 12 acts as a mixing chamber for mixing the inputted audio with the natural guitar sound and without substantially negatively affecting the natural frequency of the soundboard 22. The result is a well-mixed sound emanating from the guitar body 12.

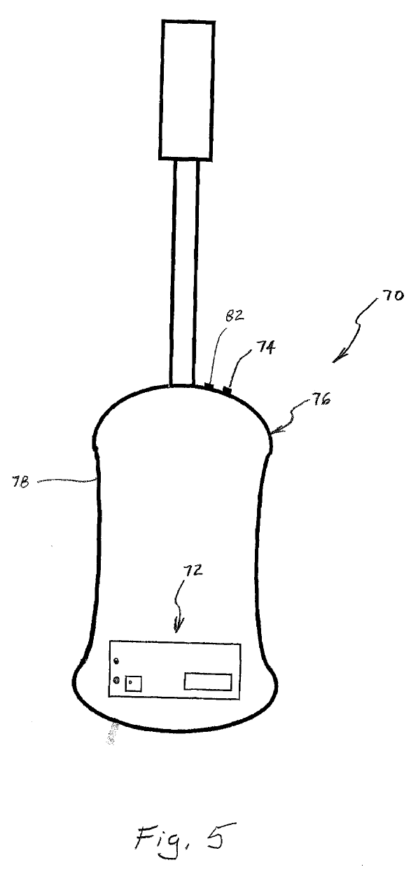

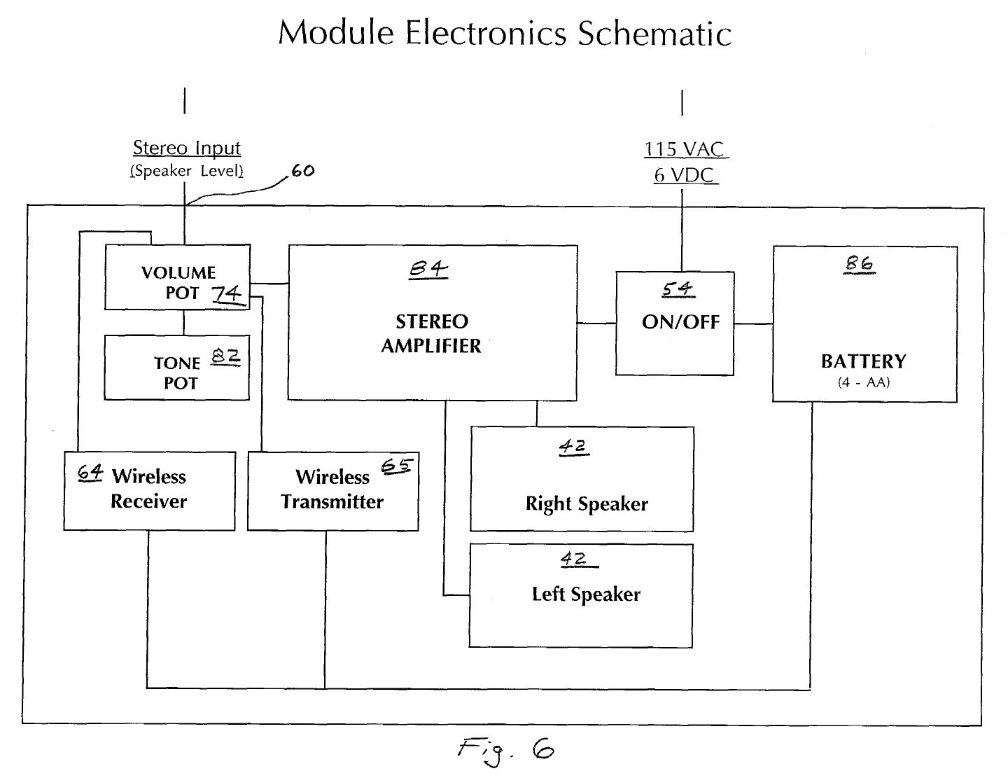

The guitar 70 illustrated in FIG. 5 is slightly different than the guitar illustrated in FIGS. 1 and 2. The guitar 70 includes a sound module 72 that does not have the volume control. Instead, the volume control 74 has been moved to the side wall 76 of the body 78 in the upper bout. A tone control 82 is positioned next to the volume control 74. This positioning of the volume and tone controls 74, 82 provides a different location for accessing these controls. Wires connecting the sound module 72 and the controls 74, 82 are positioned inside the body 78 of the guitar 70.

The electrical schematic of FIG. 6 illustrates the basic internal electrical components of the sound module 32. As shown, the sound module 32 includes a stereo amplifier 84 coupled to the left and right speakers 42. The sound module 32 further includes the power switch 54 that controls power to the amplifier 84, the power being provided by either an external power input (6 volt DC from external source) or a battery power supply 86. Audio is provided to the amplifier by either the stereo input 60 (e.g., headphone jack from an audio device) or the wireless receiver 64 (e.g., an FM receiver). The audio can also be transmitted wirelessly by the wireless transmitter 65 to a remote receiver. Volume and tone of the audio can be controlled by a volume pot and a tone pot.

1. A musical instrument comprising:
a body defining a substantially hollow volume;
a neck coupled to the body;
at least one string tensioned between the body and the neck, the string and body adapted to produce an instrument sound; and
a sound module positioned to inject external audio into the hollow volume such that the body acts as a mixing chamber to mix external audio with the instrument sound.

2. A musical instrument as claimed in claim 1, wherein the sound module includes a speaker having a front surface communicating directly with the hollow volume.

3. A musical instrument as claimed in claim 1, wherein the sound module includes an amplifier.

4. A musical instrument as claimed in claim 1, wherein the sound module includes a power switch.

5. A musical instrument as claimed in claim 1, wherein the sound module includes a volume control.

6. A musical instrument as claimed in claim 1, wherein the sound module includes an audio input.

7. A musical instrument as claimed in claim 6, wherein the audio input includes a wireless audio input.

8. A musical instrument as claimed in claim 6, wherein the audio input includes an audio input jack.

9. A musical instrument as claimed in claim 1, wherein the sound module includes a battery compartment.

10. A musical instrument as claimed in claim 1, wherein the body includes a soundboard generally defining a plane, wherein the sound module includes a speaker having a front surface facing in a direction that is not perpendicular to the plane.

11. A musical instrument as claimed in claim 10, wherein the front surface of the speaker faces in a direction that is angled at least about thirty degrees from being perpendicular to the plane.

12. A musical instrument as claimed in claim 11, wherein the front surface of the speaker faces in a direction that is angled at least about sixty degrees from being perpendicular to the plane.

13. A musical instrument as claimed in claim 12, wherein the front surface of the speaker faces in a direction that is angled about ninety degrees from being perpendicular to the plane.

14. A musical instrument as claimed in claim 1, wherein the body includes a soundboard and a back wall opposite the soundboard, wherein the body defines an upper bout and a lower bout, and wherein the sound module is positioned in the lower bout and is not directly supported by the soundboard.

15. A musical instrument as claimed in claim 14, wherein the sound module is supported by the back wall.

16. A musical instrument comprising:
a body defining a substantially hollow volume and having a sound board generally defining a plane;
a neck coupled to the body;
at least one string tensioned between the body and the neck; and
a sound module including a speaker having a front surface facing in a direction that is not perpendicular to the plane.

17. A musical instrument as claimed in claim 16, wherein the front surface of the speaker faces in a direction that is angled at least about thirty degrees from being perpendicular to the plane.

18. A musical instrument as claimed in claim 17, wherein the front surface of the speaker faces in a direction that is angled at least about sixty degrees from being perpendicular to the plane.

19. A musical instrument as claimed in claim 18, wherein the front surface of the speaker faces in a direction that is angled about ninety degrees from being perpendicular to the plane.

20. A musical instrument comprising:
a body defining a substantially hollow volume and having a soundboard and a back wall opposite the soundboard, the body defining an upper bout and a lower bout;
a neck coupled to the upper bout;
at least one string tensioned between the neck and the lower bout; and
a sound module that is not directly supported by the soundboard.

21. A musical instrument as claimed in claim 20, wherein the sound module is supported by the back wall.
